(19) United States
(12) Patent Application Publication
(10) Pub. No.: US 2023/0386684 A1
(43) Pub. Date: Nov. 30, 2023

(54) METHOD AND APPARATUS FOR PRESENTING A TARGET FUEL CAPSULE TO A PLURALITY OF ENERGY BEAMS

(71) Applicant: Dwight A. Harrienger, Webster, NY (US)

(72) Inventor: Dwight A. Harrienger, Webster, NY (US)

(21) Appl. No.: 18/202,576

(22) Filed: May 26, 2023

Related U.S. Application Data
(60) Provisional application No. 63/347,303, filed on May 31, 2022.

(51) Int. Cl. G21B 1/23; G21B 1/19

(52) U.S. Cl. CPC G21B 1/23; G21B 1/19

(57) ABSTRACT

A target compensator is provided for rotating a target fuel capsule within a target volume of a fusion ignition system. The target compensator includes a first frame rotatably connected to a mounting frame and a second frame rotatably connected to the first frame. A first drive is connected to the first frame to rotate the first frame relative to the mounting frame and a second drive is connected to the second frame to rotate the second frame relative to the first frame. The second frame includes a target holder to retain the target fuel capsule relative to the second frame. Rotation of the target fuel capsule about at least the first axis and the second axis enhances a uniformity of heating of the target fuel capsule. The target fuel capsule can be rotated by selective actuation of electromagnets in operable communication with magnets within the target fuel capsule.

### CROSS-REFERENCE TO RELATED APPLICATIONS

The present application claims the benefit of US Provisional patent application entitled Fusion Target Improvements, U.S. application No. 63/347,303, filed May 31, 2022, the entirety of which is hereby incorporated by reference.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND

### Field of the Invention

The present disclosure relates to energy generation in fusion ignition, and particularly to the controlled of heating a target fuel capsule, and more particularly to enhancing uniform heating of the target fuel capsule.

### Description of Related Art

Nuclear energy, a non-carbon emitting energy source, has been a key component of the world's energy production since the 1950's, and accounts for about 16% of the world's electricity production. However, nuclear energy is a complex energy source, and particularly when compared to fossil fuels. Several factors complicate the implementation of nuclear energy. For example, complications include the proliferation of nuclear materials and technologies resulting from the nuclear fuel cycle; the generation of long-lived radioactive nuclear waste requiring burial in deep geological repositories; and the availability of low cost, low carbon footprint uranium ore. In the United States alone, nuclear reactors have already generated more than 55,000 metric tons (MT) of spent nuclear fuel. In the near future, the US will have enough spent nuclear fuel to fill the Yucca Mountain geological waste repository to its legislated limit of 70,000 MT.

In the 1950's, Andrei Sakharov discussed the idea of fusion-fission engines in which a fusion reaction generates neutrons for a fission engine. Hans Bethe and Nikolai Basov expanded on his ideas in the 1970's and 1980's, as did many other groups around the world. The focus of some of these studies was on the use of fusion neutrons to generate fuel for fast nuclear reactors, although Basov and others discussed the possibility of using laser-driven fusion targets to drive a fission blanket for generating commercial power. Many proposals have also been made to use accelerators to generate neutrons that can then be used to transmute nuclear waste and generate electricity. Fusion-fission engines, however, did not advance beyond a conceptual stage. For example, LLNL investigated conceptual concepts for ICF-based fusion-fission hybrids in the 1970's. See, for example, “US-USSR Symposium on Fusion-Fission Reactors,” Jul. 13-16, 1976, Hosted by Lawrence Livermore Laboratory.

Fusion is an attractive energy option for future power generation, with two main approaches to fusion power plants now being developed. In a first approach, Inertial Confinement Fusion (ICF) uses lasers, heavy ion beams, shock ignition, impulse ignition, pulsed power or other techniques to rapidly compress capsules containing a mixture of isotopes of hydrogen, typically, deuterium (D) and tritium (T). As the capsule radius decreases and the DT gas density and temperature increase, DT fusion reactions are initiated in a small spot in the center of the compressed capsule. These DT fusion reactions generate both alpha particles and 14.1 MeV neutrons. A fusion burn front propagates from the spot, generating significant energy gain. In a second approach, Magnetic Fusion Energy (MFE) uses powerful magnetic fields to confine a DT plasma and to generate the conditions required to sustain a burning plasma and generate energy gain.

In ICF, the spherical shell of material (e.g., deuterium and tritium (DT) fuel) may be compressed several times in volume, using lasers, x-rays, or magnetic fields. In order to achieve high energy production, the compression may remain spherical without being disturbed by hydrodynamic instabilities in flight. However, achieving spherical and stable compression may be an obstacle to ignition.

In addition to striving for spherical and stable compression, prior attempts in ignition include driving the implosion with more energy, and imploding capsules with tight engineering tolerances on seed imperfections. Since the constraints are very tight, alternate schemes include relaxing the compression requirement, shock-igniting the capsule, and fast-ignition. However, each of these solutions has limitations. In particular, tight engineering and fielding constraints increase the cost of individual implosions, decreasing their attractiveness for energy production. Neither shock nor fast ignition at ignition-scale energies have been tested, and both require significant capital investment.

However, the need remains for enhancing the heating of a target fuel capsule, and particularly the uniform or controlled heating of the target fuel capsule.

### BRIEF SUMMARY OF THE INVENTION

Generally, the present disclosure provides for the selective rotation of a target fuel capsule to enhance uniform heating or selective heating of the target fuel capsule.

The present disclosure provides an apparatus and method to promote uniform heating of the target fuel capsule as well as controlled increase in energy to the target fuel capsule in the ignition. One aspect of the present disclosure includes the movement of the target fuel capsule in a manner that enhances for uniform heating. The present disclosure contemplates simultaneously moving the target fuel capsule about at least two axes instead of a stationary target or a single axis rotational movement. The present disclosure provides the use of a target compensator to simultaneously move the target fuel capsule about at least two axes or to rotate the target in such a way that the laser exposure covers the majority of the target surface like an object in an orbit would view the object below. It is contemplated that the orbit (or path) of the target fuel capsule would be continuously monitored and adjusted to provide uniform heating of the target fuel capsule to be exposed to the laser beams/energy sources.

In one configuration, the present disclosure provides for a rotation of the target fuel capsule about at least two axes to provide a full illumination of an external surface of the target fuel capsule. It is contemplated the axes of rotation may intersect or be offset. Further, as set forth below, for example, in the electromagnet configuration having a magnet within the target fuel capsule, the target fuel capsule can be rotated about a multitude of axes, wherein complete rotation about a given axis can be imparted by the system controller and the electromagnets, as well as partial rotation about a given axis.

In one configuration, the target compensator rotates the target fuel capsule, wherein the effective path of the target laser hit zone acts as though from an orbiting emitter. It is contemplated the frames of the target compensator rotate about the respective axis which causes the target fuel capsule to rotate about at least a first axis and a second axis. In one configuration, the motive force for the rotation of the frame about the respective axis is a hydraulic stream impacting a portion of the frame. In further configurations, the target compensator that has a rotation caused by other mechanisms such as motors, including but not limited to electromagnetic drives. In further configurations, the target fuel capsule is spherical and is paired with a magnet and contained within a slightly larger sphere. That is, in one configuration, the target fuel capsule is enclosed within an outer shell and a plurality of fixed electromagnets external to the outer shell are selectively actuated to impart rotation of the target fuel capsule within the outer shell. An enclosed liquid between the target fuel capsule and the outer shell allows the target fuel capsule to rotate freely within the outer shell. Magnets (or electromagnets) mounted in a pattern on the frames (rings) produce attraction and/or repulsion to the magnet within the target fuel capsule. The result is a rotation of the target fuel capsule to expose the entire external surface of the target fuel capsule to the intersecting energy beams. The target fuel capsule can be spaced from the outer shell by a friction reducing liquid, including, but not limited to boron, which may aid in the ignition process.

The present disclosure contemplates the use of multiple recording non-contact temperature sensors, configured to stream temperature data of the perimeter of the target fuel capsule simultaneously to produce a matrix of data that can be used to assess temperature uniformity of the temperature of the target fuel capsule, wherein feedback is provided to a system controller to maintain or re-establish sufficiently uniform heating of the target fuel capsule. The system controller is configured to provide control of the target compensator by Artificial Intelligence/Machine Learning (AI/ML) software that determines the path to rotate the target fuel capsule and control other parameters such as laser intensity or firing pattern to provide the necessary uniformity of heating of the target fuel capsule. The system controller can be configured to employ AI/ML to control the sequence of heating from low to medium to high in order to promote successful ignition. Data transmission can include, but is not limited to wireless/cellular connection to the controller to allow direct streaming of the data. The present system can include multiple temperature sensor depths that replicate natural design to gain an understanding of temperature with depth. In a further configuration, data transmission can be provide by the use of a remote hot spot or cellular collection. In one configuration, precise (laser guided) non-touch temperature sensing units to read temperature on the target fuel capsule, wherein each laser could have two temperature readers that observe on both sides of the laser stream to better judge the heating impact of the lasers.

The present disclosure provides a method of heating a target fuel capsule, the method including the step of rotating the target fuel capsule relative to an intersecting electromagnetic beam, wherein rotation of the target fuel capsule is configured to impart sufficiently balanced energy to achieve ignition. In one configuration, the rotation of the target fuel capsule includes simultaneous rotation of the target fuel capsule about a first axis and a second axis.

The present disclosure provides an apparatus for locating a target fuel capsule within a target volume illuminated by at least a first energy beam passing along a first transmission path and a second energy beam passing along a second transmission path, wherein a system controller selectively controls the transmission of the first energy beam along the first transmission path and the second energy beam along the second transmission path, the apparatus including a mounting frame; a first frame rotatably coupled to the mounting frame to rotate about a first axis; a first drive configured to rotate the first frame about the first axis; a second frame rotatable mounted to the first frame to rotate about a second axis; a second drive configured to rotate the second frame about the second axis; and a target support connected to the second frame and configured to retain the target fuel capsule within the target volume; wherein the system controller is configured to rotate the first frame about the first axis and the second frame about the second axis with the target fuel capsule within the target volume upon illumination by the first energy beam and the second energy beam.

### BRIEF DESCRIPTION OF THE SEVERAL VIEWS OF THE DRAWING(S)

FIG. 1 is a perspective schematic of a representative ignition system for a target fuel capsule.

FIG. 2 is schematic of a first frame and a second frame in a target compensator.

FIG. 3 is a perspective view of a further configuration of a target compensator.

FIG. 4 is perspective view of a further configuration of a target compensator having motors to rotate the frames.

FIG. 5 is a perspective view of another configuration of a target compensator.

FIG. 6 is an alternate perspective view of the target compensator of FIG. 5.

FIG. 7 is a schematic of an alternative drive for the target compensator using electromagnets to rotate a magnetized target.

FIG. 8 is a partial enlargement of a portion of FIG. 7.

FIG. 9 is a schematic of a further alternative drive for the target compensator.

FIG. 10 is a flow chart of a representative control sequence.

FIG. 11 is a schematic of the control of the target compensator.

### DETAILED DESCRIPTION OF THE INVENTION

The present system provides a target compensator 120 configured to cooperate with existing ignition systems 100, wherein the present system assists in achieving the necessary temperatures at a target fuel capsule 130 to initiate ignition.

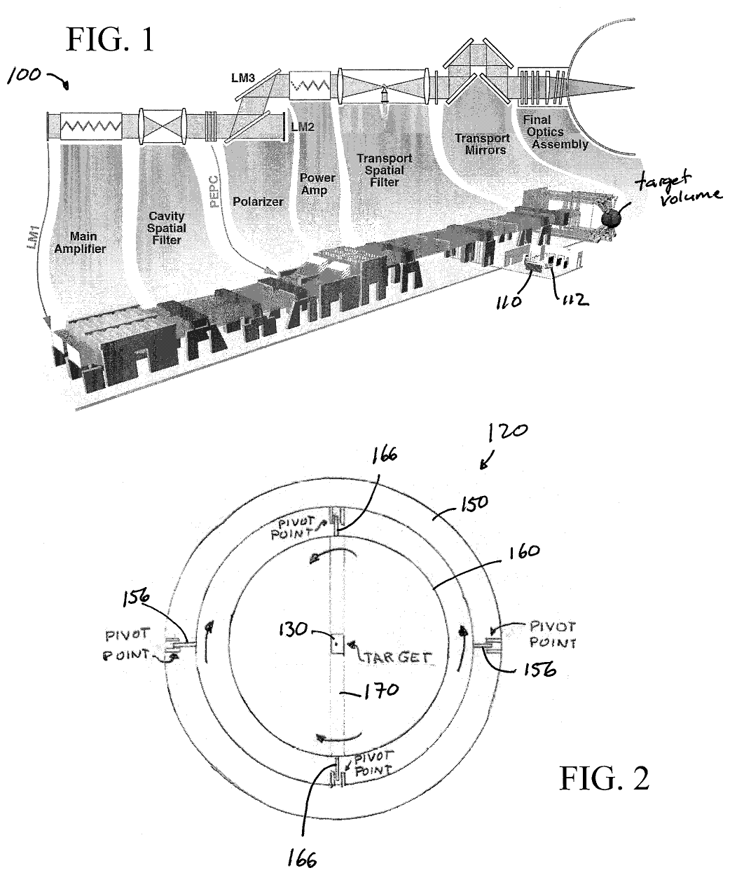

Referring to FIG. 1, the representative ignition system 100 is disclosed, wherein a relatively low power laser pulse, such as on the order of 1 billionth of a joule, is created, split, and passed along optical fibers to 48 preamplifiers that increase the energy of the pulse by a factor of 10 billion, to a few joules. Each of the resulting 48 beams is then split into four beams, for injection of each resulting beam into the 192 main laser amplifier beamlines, wherein the main laser amplifier beamlines converge at a target volume.

Laser mirrors (LM1, LM2, LM3), guide each beam through two large glass amplifiers, first through the power amplifier and then into the main amplifier. In the main amplifier, a special optical switch called a plasma electrode Pockels cell (PEPC) traps the light, forcing the light to travel back and forth four times, while special deformable mirrors, spatial filters, and other devices ensure the beams are high quality, uniform, and smooth.

From the main amplifier, the beam makes a final pass through the power amplifier. At this point in the path, the total energy of the beams has grown from approximately 1 billionth of a joule to approximately 4 million joules within a few millionths of a second.

The 192 beams are split into quads of 2×2 arrays by a series of transport mirrors. Each quad then passes through a final optics assembly, where the laser pulses are converted from 4 million joules in the infrared wavelength to more than 2 million joules at an ultraviolet wavelength. The ultraviolet wavelength are then focused onto the target volume in the target chamber. In one configuration, the 192 laser beams travel about 1,500 meters from their birth to their destination at the center of the spherical target chamber, which requires approximately 5 microseconds.

Thus, the ignition system 100 operates as a laser amplifier. The ignition system 100 employs flashes of white light from giant flashlamps to “pump” electrons in large slabs of laser glass to a higher-energy state that lasts only about one-millionth of a second.

A small pulse of laser light “tuned” to the excited electrons' energy is directed through the glass slabs. This laser pulse stimulates the electrons to drop to their lower, or ground, energy states and emit laser photons of exactly the same wavelength. The initial low-energy pulse is amplified by more than a quadrillion times to create 192 highly energetic, tightly focused laser beams that converge in the center of the target chamber.

In one configuration, the target fuel capsule 130 includes two forms of hydrogen, deuterium (D) and tritium (T). In one configuration, the target fuel capsule 130 can include a hohlraum, wherein the DT is suspended inside the hohlraum. Thus, the target fuel capsule 130 is disposed within a hohlraum. When the target fuel capsule (or hohlraum) 130 is heated in the target volume by the lasers to temperatures of more than 3 million degrees Celsius, the resulting x rays heat and blow off, or ablate, the surface of the target fuel capsule, called the ablator. This causes an implosion that compresses and heats the DT fuel to extreme temperatures and densities until the hydrogen atoms fuse, creating helium nuclei (alpha particles) and releasing high-energy neutrons and other forms of energy.

If the implosion is symmetrical and compression and temperature in the “hot spot” at the center of the capsule are sufficient, the resulting alpha particles will spread through and heat the surrounding cold fuel, triggering a self-sustaining fusion reaction. This process can generate energy equaling or exceeding the energy delivered to the target, a condition known as ignition.

The ignition system 100 includes a system controller 110 which is operably coupled to the components of the ignition system. In one configuration, the system controller 110 is configured as set forth in the present flow charts to coordinate the energizing the target and the operation of the target compensator 120.

In one configuration, the present system provides the target compensator 120 to increase the uniform heating of the target fuel capsule. Generally, it is contemplated that by rotating the target fuel capsule within the target volume, the impacting energy is more uniformly distributed about the target fuel capsule and thus more uniform heating of the target fuel capsule is provided. As used herein, the target fuel capsule includes the hohlraum, such that the heating of the hohlraum can be also controlled by the target compensator 120.

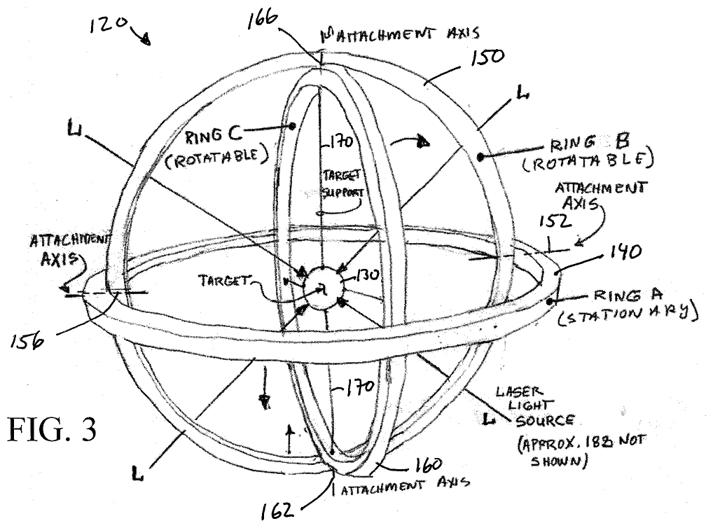

Referring to FIG. 3, the target compensator 120 includes a mounting frame 140; a first frame 150 rotatably coupled to the mounting frame to rotate about a first axis 152; a first drive 154 configured to rotate the first frame about the first axis; a second frame 160 rotatable mounted to the first frame to rotate about a second axis 162; a second drive 164 configured to rotate the second frame about the second axis; a target support 170 connected to the second frame and configured to retain the target fuel capsule 130 within the target volume. The target compensator 120 further includes a controller 132 or cooperate with the system controller 110 as configured to implement the algorithms as set forth herein.

Referring to FIG. 3, in one configuration, the mounting frame 140 is the outermost frame and is configured as a ring.

The first frame 150 is rotatably connected to the mounting frame 140 at a pair of opposing first shafts 156, wherein the first shafts are colinear across a diameter of the mounting ring. In one configuration, the first frame 150 is ring shaped and includes bushings to receive the respective opposed first shafts 156 to be rotatable about the first axis 152 relative to the mounting frame 140.

In one configuration, at least one of the first shafts 156 is fixedly connected to the first frame 150 and rotates relative to the mounting frame 140. Thus, a rotation of the first shaft 156 imparts a rotation of the first frame 150 about the first axis 152. It is contemplated the first frame 150 may rotate relative to one of the first shafts 156. In one configuration, the first axis 152 and the second axis 162 are orthogonal. However, it is understood the first axis 152 and the second axis 162 can be offset and/or inclined relative to each other.

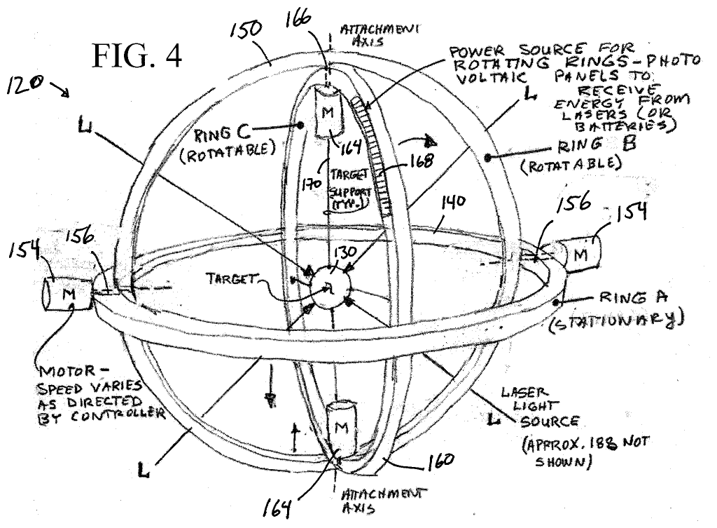

Referring to FIG. 4, at least one of the first shafts 156 is operably engaged with a first drive 154, such as an electric motor. The first drive motor 154 is connected to the corresponding first shaft 156 and imparts a rotation of the first shaft. In one configuration, the first drive motor 154 is operably connected to the system controller 110, wherein the system controller is configured to control the first drive motor and hence the rotation of the first frame 150 about the first axis 152. The first drive motor 154 can be a hydraulic motor, or an electrical motor, such as but not limited to, an AC motor or a DC motor. The DC motor can include, but is not limited to, a Permanent Magnet DC Motor (PMDC Motor; a Separately Excited DC Motor; a Self Excited DC Motor; a Shunt Wound DC Motor; a Series Wound DC Motor; a Compound Wound DC Motor; a Short shunt DC Motor; a Long shunt DC Motor; and a Differential Compound DC Motor.

The first drive motor 154 is mounted to the mounting frame 140 and connected to the first shaft 156. It is contemplated that a single first drive motor 154 can be employed. However, it is understood each of the first shafts 156 can be operably connected to a corresponding first drive motor 154, thereby providing rotation of the first frame 150 about the first axis 152 under control of the system controller 110.

The second frame 160 is rotatable connected to the first frame 150 at a pair of opposing second shafts 166, wherein the second shafts are colinear across a diameter of the first frame. In one configuration, the second frame 160 is ring shaped and includes bushings to receive the respective opposed second shafts 166 to be rotatable about a second axis 162 relative to the first frame 150. In one configuration, depending on the configuration of the target fuel capsule 130, the first axis 152 and the second axis 162 intersect. However, it is contemplated that the first axis 152 and the second axis 162 may be offset, and perpendicular, as well as offset and inclined to each other.

At least one second drive 164 is carried by the second frame 160 and connected to one of the second shafts 166 for imparting rotation of the second frame (such as the ring) about the second axis 162.

At least one of the second shafts 166 is operably engaged with the second drive motor 164. The second drive motor 164 is connected to the corresponding second shaft 166 and imparts a rotation of the second shaft. In one configuration, the second drive motor 164 is operably connected to the system controller 110, wherein the system controller is configured to control the second drive motor and hence the rotation of the second frame about the second axis 162. The second drive motor 164 can be an electrical motor, such as but not limited to, an AC motor or a DC motor. The DC motor can include, but is not limited to a Permanent Magnet DC Motor (PMDC Motor; a Separately Excited DC Motor; a Self Excited DC Motor; a Shunt Wound DC Motor; a Series Wound DC Motor; a Compound Wound DC Motor; a Short shunt DC Motor; a Long shunt DC Motor; and a Differential Compound DC Motor or a brushless motor.

Both the first drive 154 and the second drive 164 can include gearing such that an actual spinning of the motive component of the drive is increased through a gearing ratio, such that the resulting imparted rotation may be on the order of 10,000 rpm to 100,000 rpm, and depending on the drive and the gearing up to 800,000 rpm. Such rotational speeds are comparable to air turbine driven dental drills.

It is contemplated that a single second (or third) drive can be employed. However, it is understood each of the second/additional axles can be operably connected to a corresponding second drive, thereby providing rotation of the second frame 160 about the second axis 162 under control of the system controller 110.

It is further contemplated that a third, fourth, or more frames can be included, which each successive frame is rotatably mounted to the preceding next larger or outer frame. Accordingly, additional drives for each frame can be provided, wherein each additional drive is operably connected to the system controller.

Referring to FIG. 4, one of the frames, such as the second frame 160 can include a solar collector 168 which is operably connected to the second drive 164, wherein the solar collector is configured to provide electricity to the second drive. The solar collector 168 can be configured to intersect at least one of the ignition beams or a separate illuminating/power beam. It is contemplated the solar collector 168 can be configured to intersect a dedicated drive illuminating/power beam. The solar collector 168 can be a photovoltaic (PV) cell such as a ribbon mounted on the second frame 160. It is further contemplated the solar collector 168 can be located on the mounting frame 140 and/or the first frame 150.

The second drive 164 can further include a wireless communication module 167 with the system controller 110, wherein the system controller controls the operation of the second drive and hence rotation of the second frame 160 about the second axis 162.

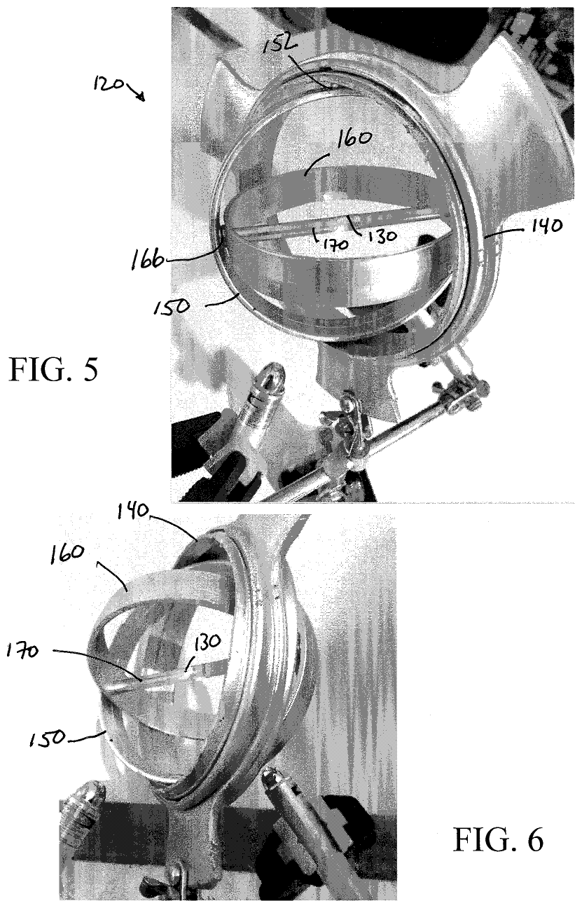

The second frame 160 further includes a target support 170 configured to engage the target fuel capsule 130 and retain the target fuel capsule for rotation with the second frame. The target support 170 is selected to couple the target fuel capsule 130 to the second frame 160 so that rotation of the second frame imparts the same rotation to the target fuel capsule. As the mass of the target fuel capsule 130 is anticipated to be relative low, the target support 170 does not need to accommodate significant inertial mass. In one configuration, the target support 170 is comprised of metal rods or cables attached to the interior of the inner most ring as shown on FIGS. 3, 4, and 7. FIGS. 5 and 6 show a further configuration of the target compensator 120.

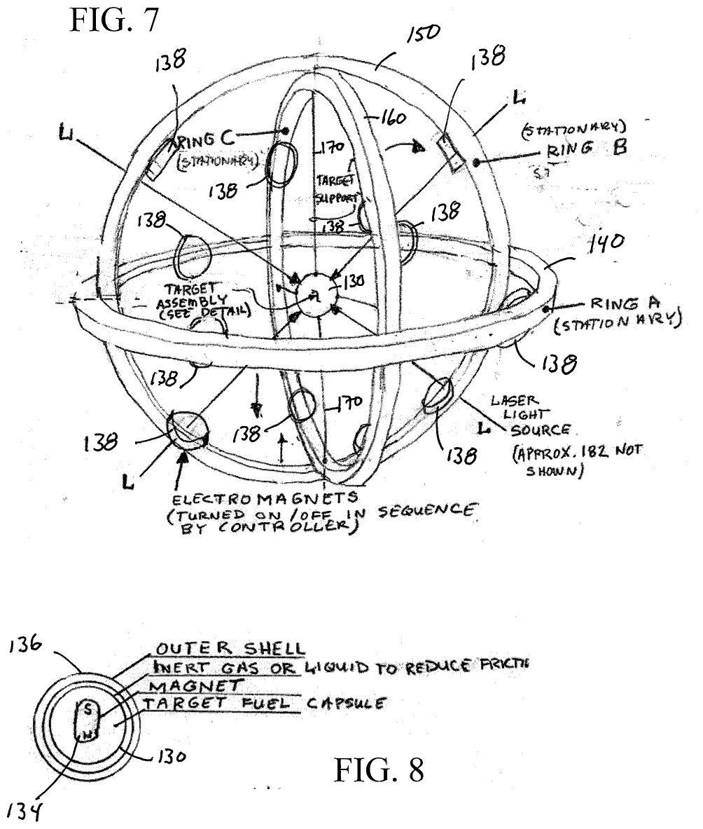

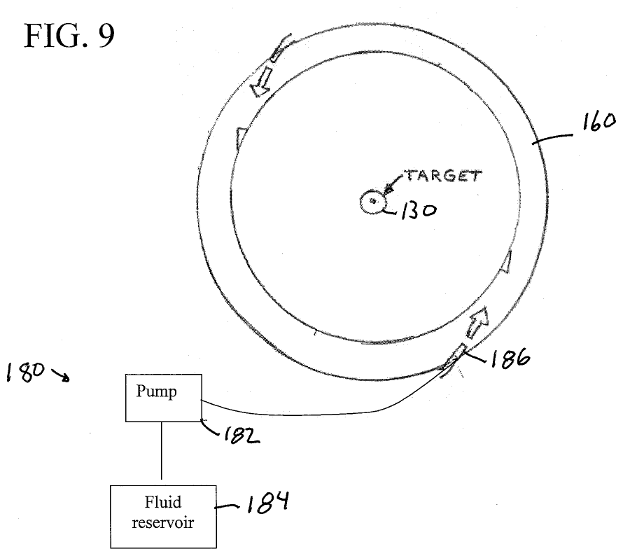

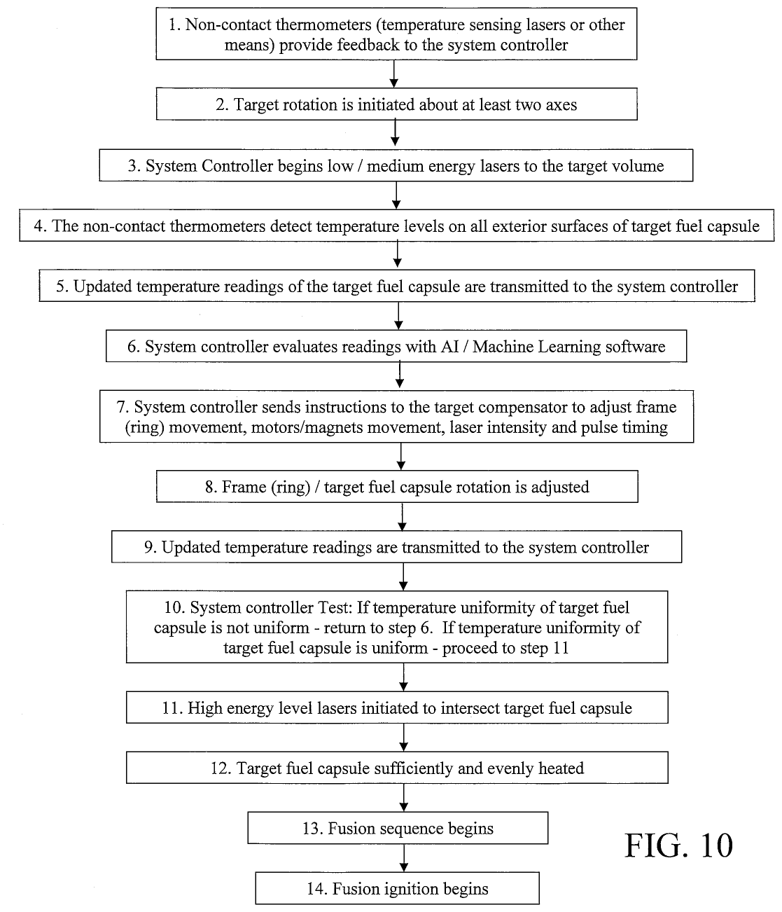

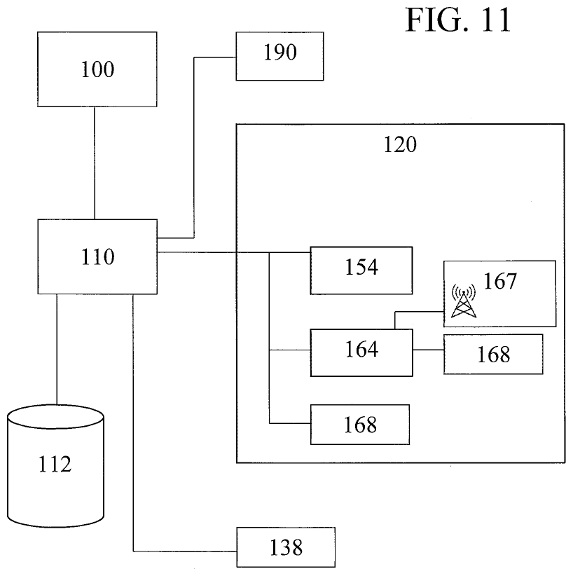

As seen in FIG. 7, in a further configuration, the target fuel capsule 130 includes at least one core magnet 134, as shown in FIG. 8. In one configuration, the target fuel capsule 130 includes the core magnet 134 having a north pole and a south pole, wherein the core magnet and the fuel rotate relative to a fixed outer shell 136 that is held by the target support 170. To facilitate rotation of the target fuel capsule 130 relative to the outer shell 136, an inert gas or liquid is disposed between the outer shell and the inner target fuel capsule having the embedded core magnet 134. In this configuration, the target compensator 120 employs electromagnets 138 that are selectively energized/deenergized to pull/repel the target fuel capsule, via the core magnet 134, within the outer shell 136 to rotate the target fuel capsule within the outer shell. Thus, at least one, and in certain configurations a plurality of electromagnets 138 are disposed on at least one of the first frame 150 and the second frame 160, wherein in select configurations, a remaining one of the frames can include a plurality of fixed magnets. It is further contemplated that the electromagnets 138 can also be located on the mounting frame 140. The electromagnets 138 are operably connected to the system controller 110, which is configured to activate the individual electromagnets to interact with the magnet in the target fuel capsule 130 to impart rotation of the target fuel capsule within the outer shell 136 as retained in the target support 170. The outer electromagnets 138 would receive electrical impulses from the system controller 110 in a pattern to cause the target fuel capsule to follow (or be pushed) by the force induced by the electromagnets at a greater radius from the target fuel capsule, and thereby rotate the target fuel capsule.

In a further configuration, it is contemplated the first frame 150 and the second frame 160 can be configured as concentric nesting spheres, wherein the second frame, the second sphere, rotates within the first frame, first sphere. The second sphere has a smaller diameter than the first sphere and thus defining a spherical shell between the first sphere and the second sphere. The spherical shell between the first sphere and the second sphere can be filled with lubricant, that maintains the volume of the first sphere and the second sphere and thus provides clearance between the first sphere and the second sphere and reduce friction between the first sphere and the second sphere. Lubricants such as, but not limited to synthetic oils, as well as inert gases. In this configuration, it is contemplated the electromagnets 138 are located about the respective first frame and second frame to impart rotation of the target fuel capsule within the outer shell. It is contemplated that the system controller can actuate the electromagnets to impart the necessary rotation to achieve uniform or controlled heating of the target fuel capsule.

As seen in FIG. 8, in a further configuration, a hydraulic system 180 can be used to impart the rotation of the second frame 160 and the first frame 150. In the hydraulic system 180, a pump 182 is used to increase the pressure of a fluid from a reservoir 184, wherein the pressurized fluid is passed through nozzles 186 to impinge on a part of the frames 150, 160. In one configuration, at least two or more streams of pressurized liquid or gas are directed to impact at least one of the first frame 150 and the second frame 160 to impart rotation about the respective axis. Specifically, the hydraulic system 180 can drive the respective first frame 150 and second frame 160 to provide the rotation of the target fuel capsule 130 about at least two axes 152, 162.

The present system further includes at least one temperature sensor 190, and in select configurations at least two or more temperature sensors connected to the system controller 110 and configured to detect a temperature of the target fuel capsule 130 within the target volume. In one configuration, the temperature sensors 190 are non-contact temperature sensors, such as, but not limited to a laser guided, non-touch temperature sensor, to read a temperatures on the target fuel capsule. It is contemplated a plurality of temperature sensors 190 can be employed, wherein there is a temperature sensor for each energy beam and to be able to confirm the uniformity of the heating process. Thus, the data of the resulting heating of the target fuel capsule 130, and impacting lasers can be provided to the system controller 110 and particularly Artificial Intelligence/Machine Learning software 112 which will provide instantaneous solutions to be determined for the compensator 120. In a further configuration, the intersection of each laser and the target fuel capsule 130 is read by two temperature sensors 190, wherein the two temperature sensors are diametrically opposed across a point of impact of the laser and the target fuel capsule. The readings from the two or more temperature sensors 190 can be used by the system controller 110 to adjust rotations of the first frame 150 and the second frame 160 to enhance the uniform heating of the target fuel capsule. 130

By combining rotation of the target fuel capsule 130 about the first axis 152 and the second axis 162, the exposed portion of the target fuel capsule to the energy beams can be controlled to enhance a preferential heating, such as uniform heating of the target fuel capsule.

It is contemplated the rotation of the target fuel capsule 130 about the first axis 152 and the second axis 162 can be controlled where the rotation about the first axis and the second axis are equal, or rotation about the first axis is greater than rotation about the second axis, or rotation about the first axis is less than rotation about the second axis.

Thus, depending on the number of beams intersecting the target volume and the relative energy, or energy density of each beam, the rotation of the target fuel capsule 130 within the target volume can be adjusted to enhancing the uniformity of the heating of the target fuel capsule.

It is further contemplated the system controller 110 will synchronize the passing of the respective energy beams and the rotation of the first frame 150 and the second frame 160 to reduce or elimination the energy beams impacting the first frame or the second frame.

The system controller 110 is configured to provide control of the propulsion system by Artificial Intelligence/Machine Learning (AI/ML) software 112 that determines at least the rotation of the first frame 150 and the second frame 160. It is further contemplated the system controller 110 is configured to move the target fuel capsule 130 and control other parameters such as laser intensity or firing pattern to provide the necessary uniformity of heating of the target fuel capsule. The system controller 110 can be configured to employ Artificial Intelligence/Machine Learning (AI/ML) 112 to control the sequence of heating from low to medium to high in order to promote successful ignition. Data transmission can include, but is not limited to wireless/cellular connection to the system controller 110 to allow direct streaming of the data.

Thus, the system controller 110 is configured to monitor the temperature of portions of the target fuel capsule 130. The system controller 110 initiates adjustments to the movement of the target fuel capsule 130, or the laser intensity to create a more even heating of the target fuel capsule. Temperature can be read on various surfaces of the target by non-contact thermal reading sensors 190. The data would be evaluated by the software. Changes could be made to the rotation/orbit path and/or the intensity of some of the lasers.

The present disclosure provides an apparatus and methods to promote even heating of the target fuel capsule 130 and potential ramp-up in energy to assist the fusion sequence. The target compensator 120 provides for movement of the target fuel capsule 130 within the target volume in a manner that allows for more even heating. Thus, a present method contemplates moving the target fuel capsule 130 about the first axis of rotation 152 and the second axis of rotation 162 within the target volume instead of a stationary target or a simple a rotational movement. It is contemplated the contribution of rotation about the first axis of rotation 152 and about the second axis of rotation 162 can be adjusted to enhance uniform heating of the surface of the target fuel capsule 130.

Typical sizes of the target fuel capsule 130 can range between approximately 2 mm to approximately 6 mm in the hohlraum configuration. The first drive 154 and the second drive 164 are configured to impart a rotation of the target fuel capsule 130 about the first axis 152 and the second axis 162 of at least 5,000 revolutions per minute (rpm), and in further configurations approximately 10,000 rpm, with certain drives obtaining 100,000 to 800,000 rpms.

Further, it is contemplated, the present system can be used to impart a ramp up period of uniform heating or temperature increase of the target fuel capsule 130. That is, intersecting energy beams below ignition intensity are impinged on the target fuel capsule 130, and the target fuel capsule 130 is rotated to enhance uniform, or a controlled, increase in temperature. Once the temperature of the target fuel capsule 130 has increased a predetermined amount, the energy beams are increased to ignition intensity and the rotation of the target fuel capsule is controlled for ignition.

Thus, an apparatus is provided for heating illuminating deuterium (D) and tritium (T) fuel with least a first energy beam passing along a first transmission path and a second energy beam passing along a second transmission path, wherein the system controller 110 selectively controls the transmission of the first energy beam along the first transmission path and the second energy beam along the second transmission path, wherein the apparatus includes the target fuel capsule 130 having the core magnet 134, and deuterium (D) and tritium (T) fuel surrounding the core magnet; the outer shell 136 encapsulating the target fuel capsule and configured to accommodate rotation of the target fuel capsule relative to the outer shell; at least the first frame spaced from the outer shell; a plurality of electromagnets 138 connected to the at least the first frame 150, wherein a selective actuation of the plurality of electromagnets imparts a rotation of the target fuel capsule relative to the outer shell. It is further contemplated that there can be a liquid intermediate the and deuterium (D) and tritium (T) fuel and the outer shell.

The system controller 110 can be operably connected to the plurality of electromagnets 138 and configured to actuate the plurality of electromagnets to impart the rotation of the target fuel capsule 130 relative to the outer shell 136.

While the invention has been described in connection with several presently preferred embodiments thereof, those skilled in the art will appreciate that many modifications and changes may be made without departing from the true spirit and scope of the invention which accordingly is intended to be defined solely by the appended claims.

1. A method of heating a target fuel capsule, the method comprising:
(a) rotating the target fuel capsule relative to an electromagnetic beam, wherein rotation of the target fuel capsule is configured to impart sufficiently balanced energy to a surface of the target fuel capsule to achieve ignition of the target fuel cell.

2. The method of claim 1, wherein the energy of the electromagnetic beam is regulated to impart sufficiently balanced energy to impart ignition.

3. The method of claim 1, wherein rotating the target fuel capsule includes rotating the target fuel capsule about a first axis and a second axis.

4. The method of claim 1, wherein rotating the target fuel capsule includes rotating the target fuel capsule about at least two intersecting axes.

5. The method of claim 1, wherein rotating the target fuel capsule includes rotating the target fuel capsule by a first frame rotating about a first axis and a second frame rotatably connected to the first frame and rotatable about a second axis.

6. The method of claim 1, wherein rotating the target fuel capsule is hydraulically driven.

7. The method of claim 1, wherein rotating the target fuel capsule is electromagnetically driven.

8. The method of claim 1, further comprising monitoring a temperature of the target fuel capsule with a plurality of recording non-contact “sensors streaming temperature data of the perimeter of the target fuel capsule simultaneously to produce a matrix of data, wherein the data provides for an assessment of the uniformity of the temperature of the target fuel capsule.

9. The method of claim 1, wherein rotating the target fuel capsule is provided by a drive connected to at least one of a first frame and a second frame.

10. The method of claim 1, further comprising at least one of (i) determining a target rotation for the target fuel capsule, (ii) controlling rotation of the target fuel capsule, (iii) firing of the electromagnetic beam, and (iv) determining an energy of the electromagnetic beam by Artificial Intelligence/Machine Learning (AI/ML) software.

11. The method of claim 10, further comprising using the AI/ML to control a sequence of heating from a first temperature to a second greater temperature to a third highest temperature to promote successful ignition of the target fuel capsule.

13. The method of claim 1, further comprising sensing the temperature of the target fuel capsule at a plurality of depths.

14. The method of claim 1, further comprising providing laser guided, non-contacting temperature sensors configured to read temperature on the target fuel capsule.

15. The method of claim 14, wherein each laser includes two temperature sensors configured to observe opposing sides of the laser to assess the heating impact of the lasers.

16. An apparatus for locating a target fuel capsule within a target volume illuminated by at least a first energy beam passing along a first transmission path and a second energy beam passing along a second transmission path, wherein a system controller selectively controls the transmission of the first energy beam along the first transmission path and the second energy beam along the second transmission path, the apparatus comprising:
(a) a mounting frame;
(b) a first frame rotatably coupled to the mounting frame to rotate about a first axis;
(c) a first drive configured to rotate the first frame about the first axis;
(d) a second frame rotatable mounted to the first frame to rotate about a second axis;
(e) a second drive configured to rotate the second frame about the second axis; and
(f) a target support connected to the second frame and configured to retain the target fuel capsule within the target volume;
wherein the system controller is configured to rotate the first frame about the first axis and the second frame about the second axis with the target fuel capsule within the target volume upon illumination by the first energy beam and the second energy beam.

17. The apparatus of claim 16, wherein at least one of the first drive and the second drive includes gearing to provide a rotation rate of at least 10,000 revolutions per minute.

18. The apparatus of claim 16, wherein the system controller is further configured to synchronize transmission of the first energy beam passing along the first transmission path and the second energy beam along the second transmission path to preclude (i) intersection of the first energy beam with the first frame and the second frame, and (ii) intersection of the second energy beam with the first frame and the second frame.

19. The apparatus of claim 16, wherein the energy beam is a laser.

20. The apparatus of claim 16, wherein at least one of the first drive and the second drive is an electromagnetic drive.
